(19) United States
(12) Patent Application Publication
(10) Pub. No.: US 2012/0166215 A1
(43) Pub. Date: Jun. 28, 2012

(54) SYSTEM AND METHOD FOR MANAGING MEDICATION ADAPTATION RATE

(75) Inventors: Jae Hun CHOI, Daejeon (KR); Myung-eun LIM, Daejeon (KR); Dae Hee KIM, Daejeon (KR); Soo Jun PARK, Seoul (KR)

(73) Assignee: Electronics and Telecommunications Research Institute, Daejeon (KR)

(21) Appl. No.: 13/334,521

(22) Filed: Dec. 22, 2011

(30) Foreign Application Priority Data
Dec. 23, 2010 (KR) 10-2010-0133906

(51) Int. Cl. G06Q 50/22

(52) U.S. Cl. 705/2

(57) ABSTRACT

According to the exemplary embodiments of the present disclosure, a medication support device recognizes an identification code provided to a medicine packet, and provides a notification service (e.g., notification of not-taken medication, notification of taking medication, notification of next medication, and notification of outdoor medication) according to a medication schedule corresponding to the recognized identification code to check a medication status, and a medication management server receives the identification code recognized by the medication support device or a medication status of the user to transmit a medication schedule or synchronize the medication schedule with the medication status of the user so that medication adaptation rate of a user may be improved by systematically managing medication of the user in home, hospital, and medical institution.

### CROSS-REFERENCE TO RELATED APPLICATIONS

This application is based on and claims priority from Korean Patent Application No. 10-2010-0133906, filed on Dec. 23, 2010, with the Korean Intellectual Property Office, the disclosure of which is incorporated herein in its entirety by reference.

### TECHNICAL FIELD

The present disclosure relates to a system and method for managing medication adaptation rate, and more particularly, to a system and method for improving medication adaptation rate of a user by systematically managing medication of the user in home, hospital, and medical institution, for which a medication support device recognizes an identification code provided to a medicine packet, and provides a notification service (e.g., notification of not-taken medication, notification of taking medication, notification of next medication, and notification of outdoor medication) according to a medication schedule corresponding to the recognized identification code to check a medication status, and a medication management server receives the identification code recognized by the medication support device or a medication status of the user to transmit a medication schedule or synchronize the medication schedule with the medication status of the user.

### BACKGROUND

It is considered to be important to improve a medication adaptation rate of a patient with chronic disease for treatment and management of disease. However, it is reported that an actual medication adaptation rate remarkably decreases below 50% when additional medication management service is not provided due to a memory limitation of a patient.

Various techniques are being developed for helping a user easily adapt to a longtime medication schedule. Purposes of the technologies are to help a user take a correct dosage of medicine with a correct method at a correct time.

Generally, a conventional medication management terminal distributes pills to regular sections according to a time slot for each day to provide notification of taking medication at a specified time. In another aspect, a medicine is wrapped in a paper for sanitation and for preventing arbitrary preparations. To this end, it is required to efficiently manage a medicine packet.

According to a conventional medication support technique, each unit of medication is simply stored. According to this technique, there are no management functions of notification of a medication taking time and determination of whether a medication is taken. A special electric device may be integrated with a medicine packet to check whether a patient takes a medication. However, according to this method, a medicine packet is very complicated and a unit cost is very high.

A medication preparation system, which is capable of automatically preparing medicine as prescribed by a doctor and printing an identification code on each medicine packet, is currently introduced to large pharmacies. However, according to the conventional art, a management of medication adaptation rate of a patient cannot be supported by using a medicine packet on which an identification code is printed. Therefore, the medication preparation system according to the conventional art cannot improve the medication adaptation rate of a patient by using the medicine packet on which the identification code is printed.

### SUMMARY

The present disclosure has been made in an effort to provide a system and method for improving medication adaptation rate of a user by systematically managing medication of the user in home, hospital, and medical institution, for which a medication support device recognizes an identification code provided to a medicine packet, and provides a notification service (e.g., notification of not-taken medication, notification of taking medication, notification of next medication, and notification of outdoor medication) according to a medication schedule corresponding to the recognized identification code to check a medication status, and a medication management server receives the identification code recognized by the medication support device or a medication status of the user to transmit a medication schedule or synchronize the medication schedule with the medication status of the user.

An exemplary embodiment of the present disclosure provides a medication management system including: a medication support device configured to recognize a medicine packet by recognizing an identification code provided to the medication packet, provide one of notification services of medicine non-compliance notification, medication notification, next medication notification, and outdoor medication notification to a user according to a medication schedule corresponding to the recognized identification code, and check a medication status of the user; and a medication management server configured to receive the identification code recognized by the medication support device or the checked medication status of the user and transmit a medication schedule for the received identification code to the medication support device, or synchronize the found medication schedule according to the received medication status of the user.

Another exemplary embodiment of the present disclosure provides a medication support device including: a communication unit configured to communicate with a medication management server; an identification code recognition unit configured to recognize an identification code provided to a medicine packet; a medication management unit configured to transmit the recognized identification code to the medication management server through the communication unit, and receive a medication schedule for the recognized identification code; a medication notification unit configured to provide a notification service by comparing the identification code of the received medication schedule with the recognized identification code; a medicine recognition unit configured to recognize whether the user takes a medicine corresponding to the provided notification service; and a discharge driving unit configured to store medicine packets prescribed for the user, and move the stored medicine packets forward or backward according to the provided notification service to discharge a medicine to the user.

Yet another exemplary embodiment of the present disclosure provides a medication adaptation rate management method including: recognizing a medicine packet by recognizing an identification code provided to the medicine packet loaded on a loading box at an initial period; receiving a medication schedule for the recognized identification code by transmitting the recognized identification code to a medication management server; providing one of medicine non-compliance notification, medication notification, next medication notification, and outdoor medication notification to the user by checking the received medication schedule according to a medicine packet discharge request from the user; and synchronizing a medication status with the medication management server by checking the medication status of the user according to the notification provided to the user.

According to the exemplary embodiments of the present disclosure, a medication support device recognizes an identification code provided to a medicine packet, and provides a notification service (e.g., notification of not-taken medication, notification of taking medication, notification of next medication, and notification of outdoor medication) according to a medication schedule corresponding to the recognized identification code to check a medication status, and a medication management server receives the identification code recognized by the medication support device or a medication status of the user to transmit a medication schedule or synchronize the medication schedule with the medication status of the user so that medication adaptation rate of a user may be improved by systematically managing medication of the user in home, hospital, and medical institution.

According to the exemplary embodiments of the present disclosure, health status can be continuously managed by monitoring medication status of the user. The monitoring operation help a doctor, nurse, and family analyze a medicine taking pattern of a patient so that a medicine can be prescribed suitably for the patient.

According to the exemplary embodiments of the present disclosure, a load on a medication management server can be minimized by providing medication support for the medicine packet provided with the identification code through the medication support device with focus on providing medication notification service to a user.

According to the exemplary embodiments of the present disclosure, medication support service can be more efficiently provided to a u-health field, particularly, for patients with chronic diseases for whom medication adaption rate is very important.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a medication adaptation rate management system for a medicine packet on which an identification code is printed, according to an exemplary embodiment of the present disclosure.

FIG. 2 is a detailed diagram illustrating the medication support device of FIG. 1, according to an exemplary embodiment of the present disclosure.

FIG. 3 is a detailed diagram illustrating the discharge driving unit of FIG. 2, according to an exemplary embodiment of the present disclosure.

FIG. 4 is a flowchart illustrating a medication management method for the medication management server of FIG. 1, according to an exemplary embodiment of the present disclosure.

FIG. 5 is a flowchart illustrating the medication handling process in the medication management server of FIG. 4, according to an exemplary embodiment of the present disclosure.

FIG. 6 is a flowchart illustrating the outdoor medication handling process in the medication management server of FIG. 4, according to an exemplary embodiment of the present disclosure.

FIG. 7 is a flowchart illustrating a medication support method for the medication support device of FIG. 1, according to an exemplary embodiment of the present disclosure.

FIG. 8 is a flowchart illustrating the initial medicine packet recognition method of FIG. 7, according to an exemplary embodiment of the present disclosure.

FIG. 9 is a flowchart illustrating the medication non-compliance notification method of FIG. 7, according to an exemplary embodiment of the present disclosure.

FIG. 10 is a flowchart illustrating a method of providing the normal medication guide service of FIG. 7, according to an exemplary embodiment of the present disclosure.

FIG. 11 is a flowchart illustrating a method of providing the outdoor medication guide service of FIG. 7, according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

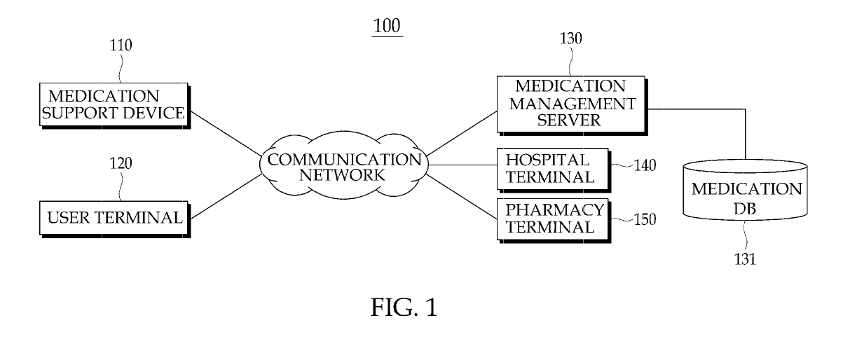

FIG. 1 is a block diagram illustrating a medication adaptation rate management system for a medicine packet on which an identification code is printed, according to an exemplary embodiment of the present disclosure.

As illustrated in FIG. 1, a medication adaptation rate management system 100 includes a medication support device 110, a user terminal 120, and a medication management server 130. Herein, medication adaptation rate management system 100 is connected to a hospital terminal 140 and a pharmacy terminal 150 through a communication network. Medication management server 130 may include a medication DB 131.

When a doctor issues a prescription for a user after treating the user, a description code is assigned to the prescription through hospital terminal 140. Hospital terminal 140 assigns the prescription code to the prescription issued by the doctor, and registers the prescription with the assigned prescription code in medication management server 130 through the communication network. For instance, hospital terminal 140 may access medication management server 130 on the basis of a web service to register the description in medication management server 130.

Pharmacy terminal 150 wraps medicines prepared according to the prescription of doctor, which is inputted by a pharmacist, in individual medicine packets connected to each other, wherein each of medicine packets is for a single dose of medication. Pharmacy terminal 150 assigns identification codes to the individual medicine packets, and prints the identification codes on certain locations of the individual medicine packets. Pharmacy terminal 150 may interoperate with an external medication preparation system to assign the identification code. Herein, hospital terminal 150 may map a single prescription code onto the identification codes on the medicine packets to collectively request registration to medication management server 130 through the communication network.

Medication management server 130 automatically generates a medication schedule of the user according to the prescription received from hospital terminal 140. Medication management server 130 maps the identification codes of medicine packets received from pharmacy terminal 150 onto the prescription code of the prescription. Medication management server 130 stores the prescription code of the prescription, the identification codes of medicine packets, and the medication schedule in medication DB 131. The medication schedule includes times for taking medicine during a medication period and medication instructions. Medication management server 130 receives the identification codes of medicine packets loaded on the medication support device 110, and checks whether the received identification codes correspond to the identification codes stored in medication DB 131. Medication management server 130 transmits the medication schedule to medication support device 110. Thereafter, medication management server 130 receives a medication status from medication support device 110 and stores the received medication status in medication DB 131 to manage a medication adaptation rate.

Meanwhile, medication management server 130 may transmit a notification message (e.g., short message, long message, or multimedia message) to user terminal 120 according to the medication schedule to thereby notify time for taking medicine and provide instructions on medication. That is, medication management server 130 may provide the medication schedule (e.g., time for taking medicine and medication instruction) corresponding to the identification code to user terminal 120 with reference to medication DB 131.

Medication support device 110 is loaded with individual medicine packets corresponding to one prescription. Medication support device 110 deciphers the identification codes printed on medicine packets and sequentially transmits the deciphered identification codes to medication management server 130. The individual medicine packets which wrap medicines prepared in a pharmacy are connected to each other, and are loaded on medication support device 110. Medication support device 110 recognizes the identification codes printed on medicine packets. Medication support device 110 transmits the recognized identification codes to medication management server 130 through the communication network. Thereafter, medication support device 110 receives the medication schedule generated by the medication management server 130 to thereby notify time for taking medicine and provide medication instructions according to the received medication schedule.

Medication support device 110 discharges medicines in response to a medicine packet discharge request from the user, and recognizes the medication status to transmit the medication status to medication management server 130. Medication support device 110 may classify the medication status into a normal medication status, a medication non-compliance status, and an outdoor medication status. Medication support device 110 may regularly provide various forms of notifications to the user under a certain condition during a medication period. Herein, in response to a medicine discharged request from the user (e.g., pushing a discharge button), medication support device 110 discharges one medicine packet, and provides instructions on the discharged medicine to the user. Medication support device 110 checks whether the user takes medicines within a time for taking a medicine and transfers a result of the check to medication management server 130. If the user does not take a medicine within a time for taking a medicine, medication support device 110 transfers the medication status of the user to medication management server 130. Then, medication management server 130 stores the medication non-compliance status of the user in medication DB 131.

The user may request a medicine discharge to medication support device 110 before a medicine discharge time to go out. In the case of discharging a medicine before a time for taking a medicine for going out, medication support device 110 informs medication management server 130 of an outing of medicine. Then, medication management server 130 stores this outdoor medication in medication DB 131. That is, medication support device 110 allows the user to discharge the medicine packet in advance when the user goes out, and transmits the outdoor medication status to medication management server 130.

User terminal 120 receives a medication notification message (e.g., short message, long message, or multimedia message) from medication management server 130. User terminal 120 may notify a time for taking medicine and provide medication instructions to the user according to the received medication notification message.

Medication management server 130 stores the prescription code of the prescription, the identification codes of medicine packets, the medication schedule, and the medication status of the user.

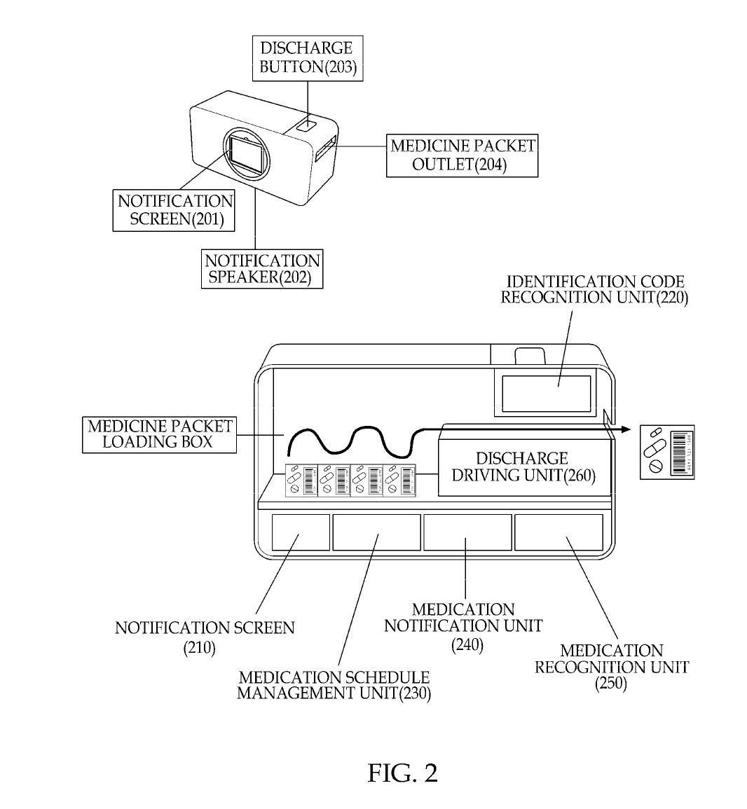

FIG. 2 is a detailed diagram illustrating the medication support device of FIG. 1, according to an exemplary embodiment of the present disclosure.

As illustrated in FIG. 2, medication support device 110 includes a communication unit 210, an identification code recognition unit 220, a medication schedule management unit 230, a medication notification unit 240, a medication recognition unit 250, and a discharge driving unit 260. Herein, for a user interface, medication support device 110 may include a notification screen 201 and a notification speaker 202 for expressing the medication notification, and a discharge button 203 and a medicine packet outlet 204 for discharging a medicine packet. The medicine packets sequentially arranged according to the medication schedule for one prescription are stored in a medicine packet loading box.

Hereinafter, components of medication support device 110 will be described in detail.

With regard to an exterior of medication support device 110, medication notification unit 240 may instruct the user to take a medicine through notification screen 201 or notification speaker 202 to provide the medication notification service. At this time, if the user pushes discharge button 203 in response to the medication notification, discharge driving unit 260 discharges a corresponding medicine packet among the sequentially arranged medicine packets through medicine packet outlet 204. Then, the user detaches one medicine packet from the connected medicine packets and takes a medicine. Discharge driving unit 260 discharges one medicine packet by operating a motor and a conveyor.

Meanwhile, communication unit 210 performs a communication operation with medication management server 130. Communication unit 210 transmits the identification codes, which are recognized by identification code recognition unit 220 during an initial medicine packet recognition process, to medication management server 130. Communication unit 210 receives the medication schedule from medication management server 130 and transmits the received medication schedule to medication schedule management unit 230. Communication unit 210 transmits the medication status recognized by medication recognition unit 250 to medication management server 130.

Identification code recognition unit 220 recognizes the identification codes printed on medicine packets during an initial process of loading medicine packets and a process of discharging medicine packets.

Medication schedule management unit 230 stores and manages the medication schedule received through communication unit 210. Medication schedule management unit 230 may be provided with a memory for storing the medication schedule.

Medication notification unit 240 provides the medication notification to the user through notification screen 201 or notification speaker 202 according to the medication schedule managed by medication schedule management unit 230. Medication notification unit 240 may expresses the medication notification message for the user according to time in the medication schedule. Herein, the medication notification may be selectively repeated before a preset time limit for taking medicine elapses.

Medication recognition unit 250 recognizes whether the user has taken or has not taken a medicine, i.e., recognizes the medication status.

Discharge driving unit 260 discharges a corresponding medicine packet among the sequentially arranged medicine packets through medicine packet outlet 204.

Discharge driving unit 260 may discharge one medicine packet by operating a motor and a conveyor. Discharge driving unit 260 may fix the discharged one medicine packet to be easily detached by the user.

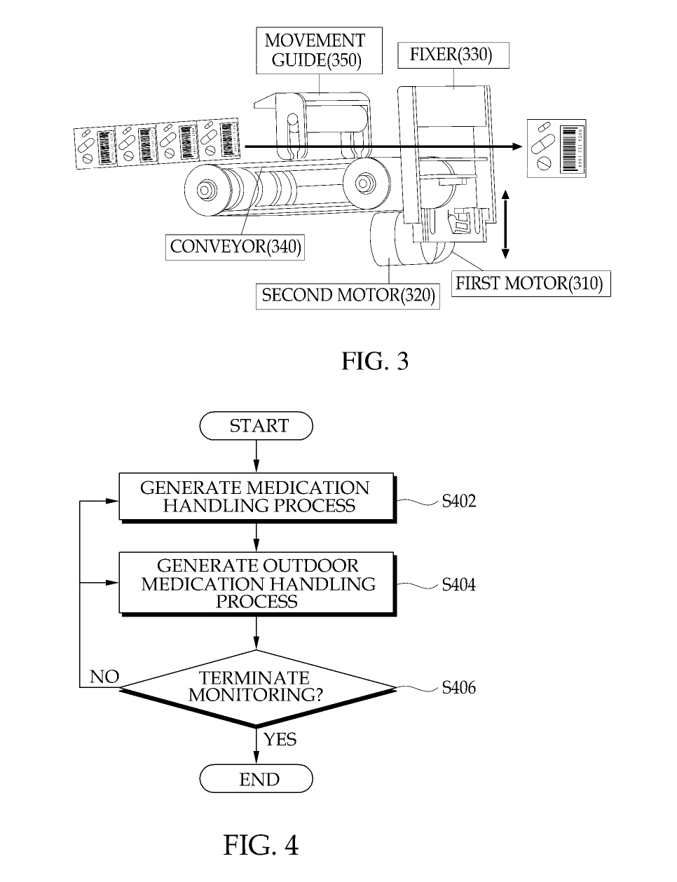

FIG. 3 is a detailed diagram illustrating the discharge driving unit of FIG. 2, according to an exemplary embodiment of the present disclosure.

As illustrated in FIG. 3, discharge driving unit 260 includes a first motor 310, a second motor 320, a fixer 330, a conveyor 340, and a movement guide 350.

Discharge driving unit 260 serves to discharge medicine packets one by one. This will be described in detail below.

Firstly, first motor 310 moves fixer 330 upward and downward.

Fixer 330 may be moved downward by first motor 310 to fix the medicine packet, or may be moved upward to move the medicine packet. For instance, if one mediated paper is discharged, fixer 330 may be moved downward by first motor 310 to fix a next medicine packet. Therefore, the user may easily detach one medicine packet.

Second motor 320 serves to move conveyor 340.

Conveyor 340 may move the medicine packet forward or backward by being moved by second motor 320. That is, conveyor 340 may discharge the individual medicine packets connected to each other one by one toward medicine packet outlet 204, or may move the individual medicine packets connected to each other backward to the medicine packet loading box.

Movement guide 350 may stabilize movement of the medicine packets by pushing the medicine packet when the medicine packets are moved by conveyor 340. In this manner, the medicine packets which are moved forward or backward by conveyor 340 correctly move toward medicine packet outlet 204.

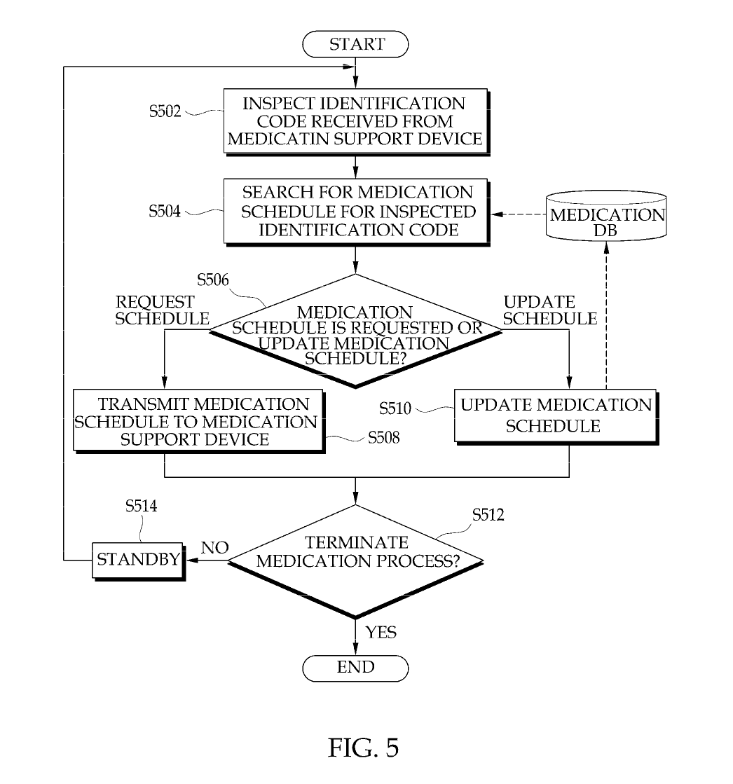

FIG. 4 is a flowchart illustrating a medication management method for the medication management server of FIG. 1, according to an exemplary embodiment of the present disclosure.

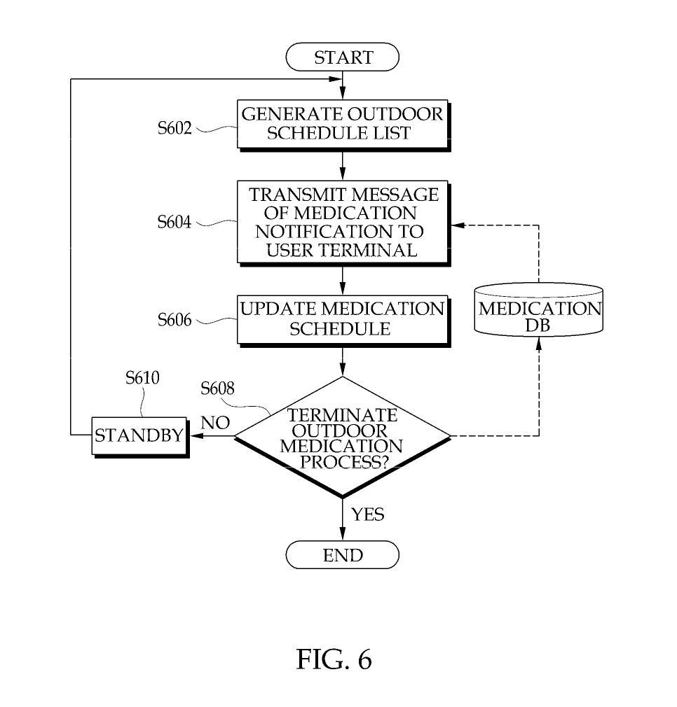

As illustrated in FIG. 4, medication management server 130 generates a medication handling process and an outdoor medication handling process. These operations will be described in detail with reference to FIGS. 5 and 6.

Medication management server 130 generates the medication handling process in operation S402. With regard to the medication handling process, medication management server 130 receives the identification codes of medicine packets from medication support device 110. Medication management server 130 searches for the medication schedule (e.g., time for taking medicine and medication instructions) corresponding to the received identification code in medication DB 131. Medication management server 130 transmits the found medication schedule to medication support device 110. Thereafter, medication management server 130 receives the medication status from medication support device 110 and stores the received medication status in medication DB 131.

Meanwhile, medication management server 130 generates the outdoor medication handling process in operation S404. The outdoor medication handling process is generated when medication support device 110 discharges a medicine for an outing of the user. With regard to the outdoor medication handling process, the outdoor medication handling process is for providing the medication notification service to the user when the user goes out. Medication management server 130 additionally generates an outdoor medication schedule according to the outdoor medication handling process to transmit the medication notification message to user terminal 120. Medication management server 130 receives the medication status from user terminal 120 and stores the received medication status in medication DB 131.

Medication management server 130 checks whether the medication handling process or outdoor medication handling process is to be terminated in operation s406.

According to a result of the check in operation S406, in the case of process termination, medication management server 130 terminates the medication handling process or outdoor medication handling process. On the contrary, according to the result of the check in operation S406, in the case that the process is not to be terminated, medication management server 130 performs operations again from operation S402.

FIG. 5 is a flowchart illustrating the medication handling process in the medication management server of FIG. 4, according to an exemplary embodiment of the present disclosure.

In FIG. 5, a handling process, which is performed by medication management server 130 for a medication service requested from medication support device 110, is illustrated in detail.

Medication management server 130 receives the identification codes from medication support device 110 and inspects the received identification codes in operation S502. Medication management server 130 may recognize medication support device 110 through the inspected identification codes.

Medication management server 130 searches for the medication schedule (e.g., time for taking medicine and medication instructions) for the inspected identification codes in medication DB 131 in operation S504.

Medication management server 130 checks whether a request corresponding to the identification codes from medication support device 110 is for transmitting the medication schedule or updating the medication schedule in operation S506.

According to a result of the check in operation S506, if the request is for transmitting the medication schedule, medication management server 130 transmits the found medication schedule to medication support device 110 in operation S508.

On the contrary, according to the result of the check in operation S506, if the request is for updating the medication schedule, medication management server 130 updates the medication schedule stored in medication DB 131 according to updated content transmitted from medication support device 110 in operation S510. For instance, medication management server 130 may update the medication schedule as one of medication notification status, medication outing status, medication non-compliance status, outdoor medication status, and unidentified status, and store the updated medication schedule in medication DB 131.

Medication management server 130 checks whether a medication process is to be terminated in operation S512.

According to a result of the check in operation S512, in the case that the medication process is not to be terminated, medication management server 130 remains in a standby state in operation S514, and then performs operations again from operation S502. On the contrary, according to the result of the check in operation S512, if the medication process is to be terminated, medication management server 130 terminates the medication process. In this manner, medication management server 130 may repeatedly perform the medication handling process.

FIG. 6 is a flowchart illustrating the outdoor medication handling process in the medication management server of FIG. 4, according to an exemplary embodiment of the present disclosure.

In FIG. 6, a handling process, which is performed by medication management server 130 for an outdoor medication service requested from medication support device 110, is illustrated in detail.

If medication management server 130 receives the outdoor medication request from medication support device 110, medication management server 130 searches for an outdoor medication schedule requested after a current time in the medication schedule stored in medication DB 131 to generate an outdoor schedule list in operation S602. A medication schedule, which needs the medication notification during an outing of the user, is included in the outdoor schedule list.

Medication management server 130 transmits the medication notification message to user terminal 120 according to the generated outdoor schedule list in operation S604. The medication notification message may be transmitted in various forms of message, and may include a time for taking medicine and medication instructions.

Thereafter, medication management server 130 updates the outdoor schedule list so that an outdoor schedule for which the medication notification message has been transmitted is updated as the outdoor medication status in operation S606.

Thereafter, medication management server 130 checks whether the outdoor medication process is to be terminated in operation S608.

According to a result of the check in operation S608, if the outdoor medication process is not to be terminated, medication management server 130 remains in a standby state in operation S610, and then performs operations again from operation S604. On the contrary, according to the result of the check in operation S608, if the outdoor medication process is to be terminated, medication management server 130 terminates the outdoor medication process. In this manner, the outdoor medication process is continuously repeated.

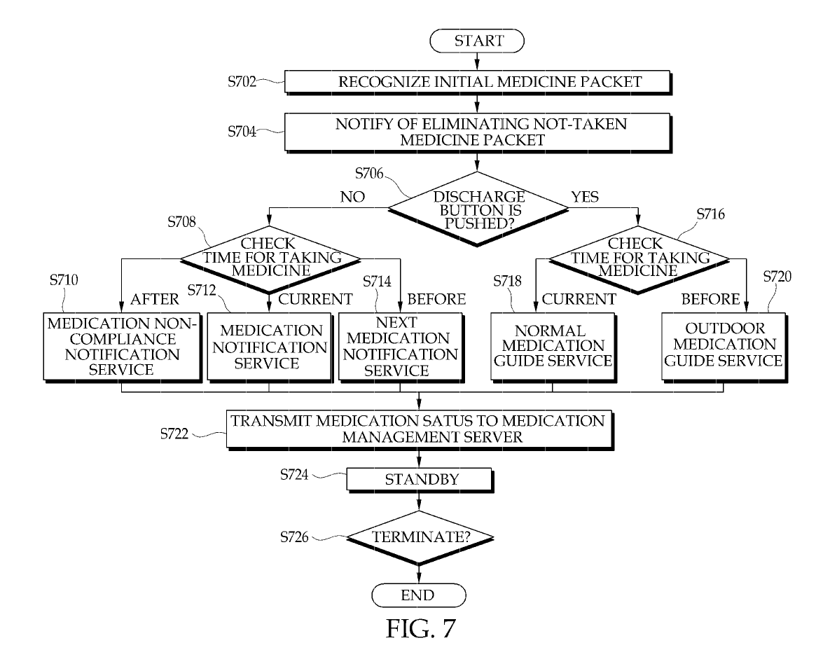

FIG. 7 is a flowchart illustrating a medication support method for the medication support device of FIG. 1, according to an exemplary embodiment of the present disclosure.

Firstly, medication support device 110 performs an initial medicine packet recognizing process in operation S702. Medication support device 110 moves the medicine packets to an initial location when the user inserts the sequentially connected medicine packets into medication support device 110 or when the power is turned on. Medication support device 110 performs the initial medicine packet recognizing process so that a reader provided to the medication support device 110 recognizes the identification codes of medicine packets.

Then, medication support device 110 performs a not-taken medicine packet elimination notification process to eliminate not-taken medicine packets, which should have been discharged, in operation S704.

Then, medication management server 110 checks whether discharge button 203 is pushed by the user in operation S706.

According to a result of the check in operation S706, in the case that discharge button 203 is not pushed, medication support device 110 checks a time for taking a medicine in operation S708.

According to a result of the check in operation S708, if a current time is after the time for taking a medicine, medication support device 110 provides a medication non-compliance notification service to the user in operation S710.

According to a result of the check in operation S708, if a current time is the time for taking a medicine, medication support device 110 provides the medication notification service to the user in operation S712. Herein, medication support device 110 may provide the medication notification service by expressing that a current time is for taking a medicine through notification screen 201 or notification speaker 202.

According to the result of the check in operation S708, if a current time is before the time for taking a medicine, medication support device 110 provides the next medication notification service to the user in operation S710. Medication support device 110 may display a time for taking a current medicine on notification screen 201 or express the time in sound through notification speaker 202.

Meanwhile, according to the result of the check in operation S706, in the case that discharge button 203 is pushed, medication support device 110 checks a time for taking a medicine in operation S716.

According to a result of the check in operation S716, if a current time is the time for taking a medicine, medication support device 110 provides a normal medication guide service to the user in operation S718. Medication support device 110 discharges the medicine packet and provides medication instructions so that the user takes a medicine. The medication instructions may include content of medicine, medicine taking method, medicine taking time, and matters that require attention, and may be appropriately visualized for the medication support device 110.

According to the result of the check in operation S716, if a current time is before the time for taking a medicine, medication support device 110 provides an outdoor medication guide service to the user in operation S720. The outdoor medication guide service is provided after an outing confirmation process is performed to prevent over dosage. Medication support device 110 discharges the medicine packet after the outing confirmation process, and instructs that the discharged medicine packet is not for current use but for later use. Medication support device 110 may cancel the outdoor medication during the outing confirmation process.

After performing operations S706 to S720, medication support device 110 transmits the medication status of the user to medication management server 130 in operation S722. In this manner, medication management server 130 may monitor the medication status of the user.

Then, medication management server 110 stands by for a certain period of time in operation S724, and checks whether the medication support process is to be terminated in operation S726. This operation is for preventing the medication support process from being too frequently repeated.

According to a result of the check in operation S726, in the case that the medication support process is not to be terminated, medication support device 110 performs operations again from operation S704. On the contrary, according to the result of the check in operation S726, if the medication support process is to be terminated, medication support device 110 terminates the medication support process.

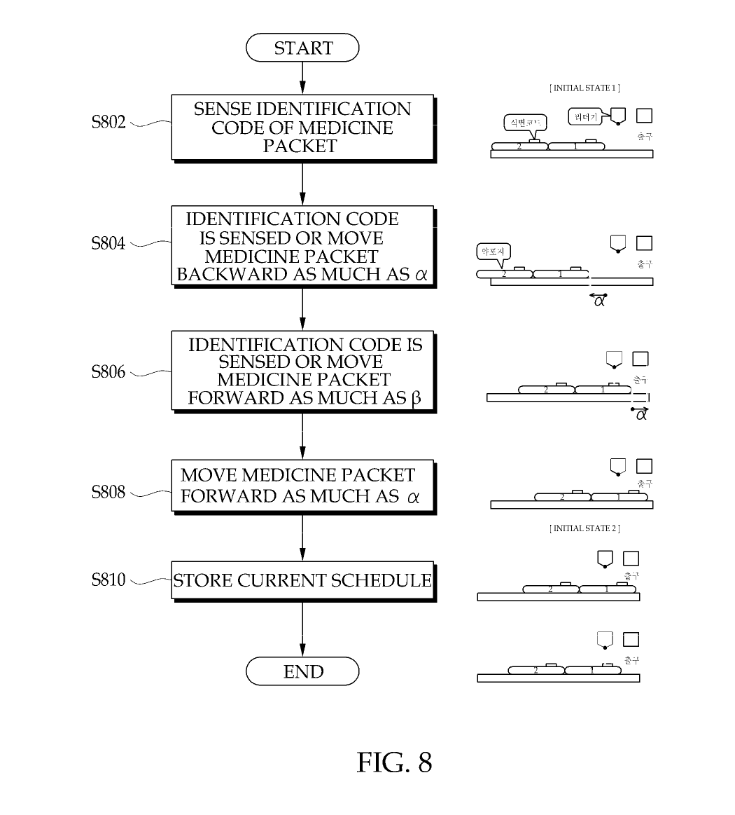

FIG. 8 is a flowchart illustrating the initial medicine packet recognition method of FIG. 7, according to an exemplary embodiment of the present disclosure.

FIG. 8 illustrates a process for initially recognizing the medicine packets. The initial medicine packet recognition process is performed for initially recognizing the medicine packets when the medicine packets are initially inserted to medication support device 110 or when medication support device 110 is restarted.

Firstly, medication support device 110 senses the identification codes printed on medicated papers through the reader in operation S802.

Then, medication support device 110 moves the medicine packets backward as much as α or until the reader senses the identification code in operation S804. Operation S804 is needed for sensing a first medicine packet when the identification code of the first medicine packet is positioned ahead of the reader as illustrated in [initial state 2]. If the medicine packets are moved backward until the identification code is sensed, the medicine packets are continuously moved backward in the case of [initial state 1]. Therefore, if the medicine packets are moved backward just as much as α, [initial state 1] is just a backward movement. If the medicine packets are moved backward just as much as α, [initial state 2] is a state of sensing the identification code. Herein, “α” is a predetermined distance between the identification codes.

Thereafter, medication support device 110 senses the identification code of the first medicine packet, or the medicine packets move forward as much as maximum distance β in operation S806. When the identification code is not sensed, even though the medicine packets move forward as much as β, an exception process is performed. Herein, “β” is a maximum distance for sensing the identification code.

Then, medication support device 110 moves the sensed first medicine packet forward as much as α so that the first medicine packet arrives at the outlet in operation S808. Herein, the process of moving medicine packet as much as α in operation S808 makes all other discharge processes performed consistently. Since operation S808 is performed right after performing operation S806, movement of the medicine packets is not stopped.

Medication support device 110 checks the medication schedule for the identification code of the sensed first medicine packet through communication with medication management server 130, and stores the checked current medication schedule, in operation S801. In this manner, medication support device 110 may provide the medication notification service to the user at a time for taking medicine.

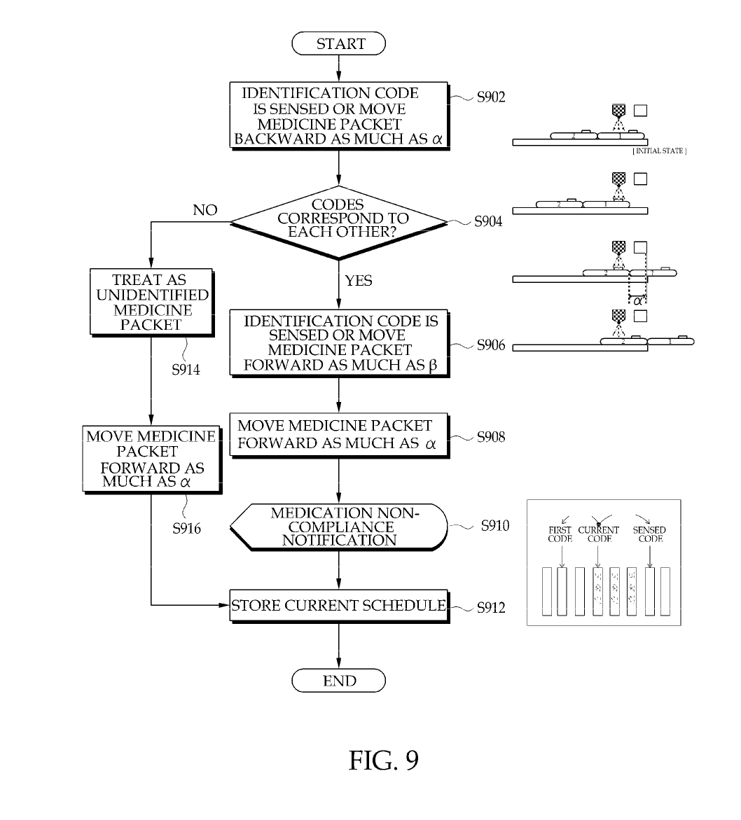

FIG. 9 is a flowchart illustrating the medication non-compliance notification method of FIG. 7, according to an exemplary embodiment of the present disclosure.

FIG. 9 illustrates a method of providing the medication non-compliance notification service. As illustrated in FIG. 9, when the user does not take a medicine within the time specified in the current medication schedule, the current medicine packet may be discharged and discarded.

Medication support device 110 senses the identification code of the medicine packet which is in [initial state], or moves the medicine packets backward as much as maximum distance β in operation S902. When the identification code is not sensed, even though the medicine packets move backward as much as β, the medicine packets are not appropriately arranged, and thus need to be rearranged.

Medication support device 110 checks whether the sensed identification code corresponds to the identification code for the current medication schedule in operation S904. This operation is for checking a not-taken medicine packet.

According to a result of the check in operation S904, when the identification codes correspond to each other, medication support device 110 senses a next identification code following the first medicine packet, or move the medicine packets forward as much as maximum distance β in operation S906. When the first medicine packet is the last medicine packet, the identification code is not sensed in spite of the maximum forward movement. When the identification code is not sensed, even though the medicine packets move forward as much as β, an exception process is performed.

Then, medication support device 110 moves the sensed first medicine packet forward as much as α so as to completely discharge the first medicine packet out of the outlet in operation S908.

Thereafter, medication support device 110 informs the user that the currently discharged medicine packet has passed the expiration date and should not be taken in operation S910.

Medication support device 110 stores the medication schedule for the identification code sensed in operation S906 as the current medication schedule in operation S912.

Meanwhile, according to a result of the check in operation S904, when the identification codes do not correspond to each other, medication support device 110 treats the medication packet having the not-corresponded identification code as an unidentified medicine packet in operation S914. That is, medication support device 110 recognizes the sensed identification code and the medication schedule corresponding thereto, and treats all medicine packets of medication schedules between the current medication schedule and the sensed medication schedule as unidentified medicine packets if a medicine taking time of the current medication schedule is prior to that of the sensed medication schedule. Medication support device 110 synchronizes the information about the unidentified medicine packets with medication management server 130.

Then, medication support device 110 moves the medicine packets forward as much as α in operation S916. This operation is for moving the medicine packets to an initial location. Then, medication support device 110 performs operation S912. This operation is for substituting the sensed medication schedule with the current medication schedule. Due to this substitution, if the medicine taking time of the medication schedule of the sensed identification code is prior to that of the medication schedule of the current identification code, all medicine packets of medication schedules therebetween are treated as not-taken medicine packets.

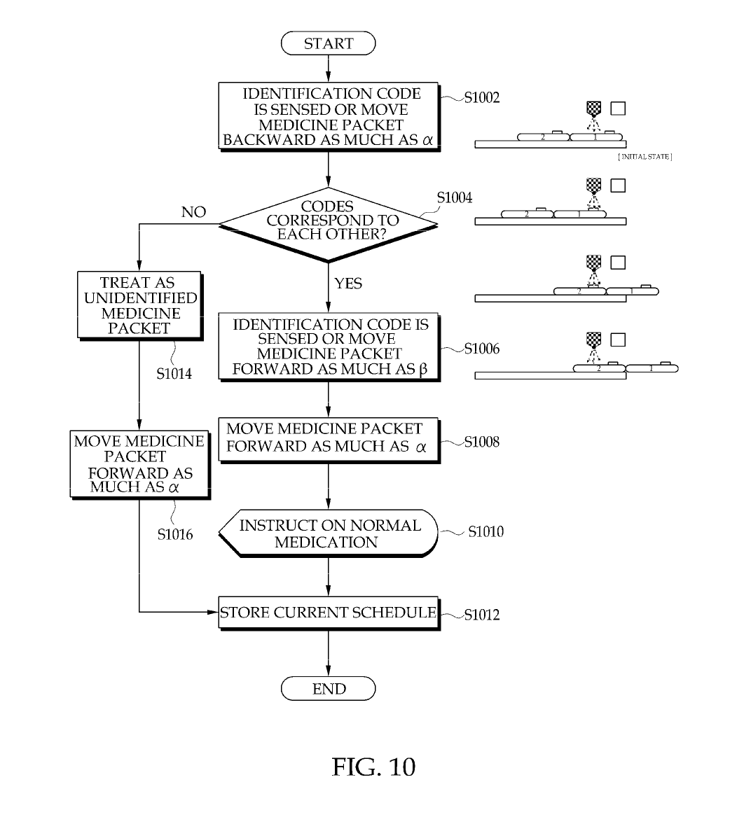

FIG. 10 is a flowchart illustrating a method of providing the normal medication guide service of FIG. 7, according to an exemplary embodiment of the present disclosure.

Medication support device 110 helps the user discharge a medicine to take the medicine within the time of the current medication schedule through the normal medication guide service method of FIG. 10.

As illustrated in FIG. 10, medication support device 110 senses the identification code of the medicine packet which is in [initial state], or moves the medicine packets backward as much as maximum distance β in operation S1002.

Medication support device 110 checks whether the sensed identification code corresponds to the identification code for the current medication schedule in operation S1004.

According to a result of the check in operation S1004, when the identification codes correspond to each other, medication support device 110 senses a next identification code following the first medicine packet, or move the medicine packets forward as much as maximum distance β in operation S1006. When the first medicine packet is the last medicine packet, the identification code is not sensed in spite of the maximum forward movement.

Then, medication support device 110 moves the sensed first medicine packet forward as much as α so as to completely discharge the first medicine packet out of the outlet in operation S1008.

Thereafter, medication support device 110 provides medicine taking method, medicine taking procedures, and matters that require attention according to the medication instructions included in the current medication schedule so that the currently discharged medicine is appropriately taken by the user in operation S1010.

Medication support device 110 receives the medication schedule for the identification code sensed in operation S1006 from medication management server 130 to store the received medication schedule as the current medication schedule in operation S1012.

Meanwhile, according to a result of the check in operation S1004, when the identification codes do not correspond to each other, medication support device 110 treats the medication packet having the not-corresponded identification code as an unidentified medicine packet in operation S1014.

Then, medication support device 110 moves the medicine packets forward as much as α in operation S1016. This operation is for moving the medicine packets to an initial location. Then, medication support device 110 performs operation S1012.

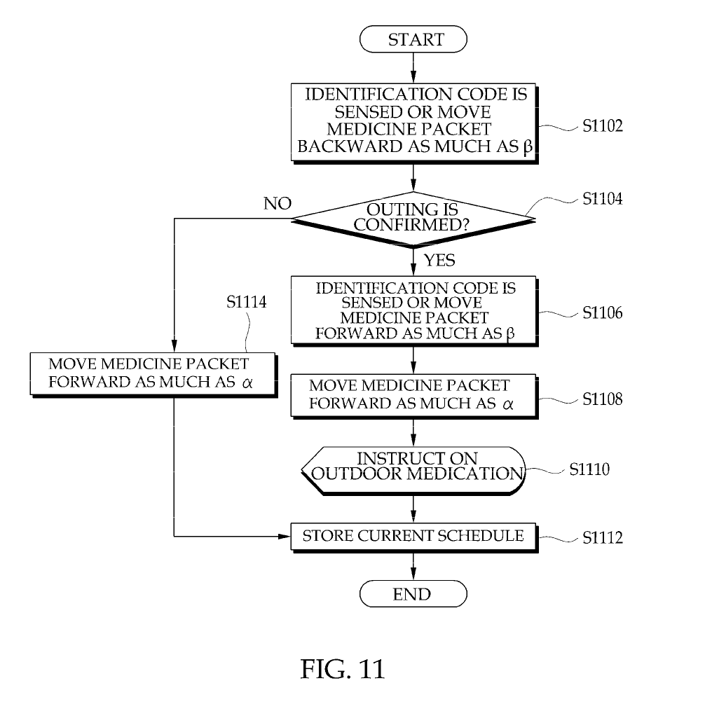

FIG. 11 is a flowchart illustrating a method of providing the outdoor medication guide service of FIG. 7, according to an exemplary embodiment of the present disclosure.

Medication support device 110 helps the user discharge a medicine to take the medicine later through the outdoor medication guide service method of FIG. 11.

As illustrated in FIG. 11, medication support device 110 senses the identification code of the medicine packet, or moves the medicine packets backward as much as maximum distance β in operation S1102.

Medication support device 110 checks whether a current medicine packet is discharged for an outdoor medication in operation S1104. Medication support device 110 may notify the user of outdoor medication, and may confirm a discharge for outdoor medication when the user pushes discharged button 203 after the outdoor medication notification is provided. On the contrary, when the user does not push discharge button 203 for a certain period of time, medication support device 110 may confirm that the medication status is not the outdoor medication status.

According to a result of the check in operation S1104, in the case of the outdoor medication, medication support device 110 senses a next identification code following the first medicine packet, or move the medicine packets forward as much as maximum distance β in operation S1106. Herein, when the first medicine packet is the last medicine packet, the identification code is not sensed in spite of the maximum forward movement.

Then, medication support device 110 moves the sensed first medicine packet forward as much as α so as to completely discharge the first medicine packet out of the outlet in operation S1108.

Thereafter, medication support device 110 provides medicine taking method, medicine taking procedures, and matters that require attention according to the medication instructions included in the current medication schedule so that the currently discharged medicine will be appropriately taken later by the user during an outing in operation S1110.

Medication support device 110 receives the medication schedule for the identification code sensed in operation S1106 from medication management server 130 to store the received medication schedule as the current medication schedule in operation S1112.

According to the result of the check in operation S1104, in the case that the medication status is not the outdoor medication status, medication support device 110 moves the medicine packets forward as much as α in operation S1114. This operation is for moving the medicine packets to an initial location. Then, medication support device 110 performs operation S1012.

Meanwhile, the above-described medication adaptation rate management method may be realized as a software program to be recorded on a computer readable recording medium, and thus may be applied to various reproducing devices.

The various reproducing devices may include a mobile terminal as the above described user terminal, a PDA, a notebook computer, a navigator, a PMP, a smartphone, an electronic dictionary, and an MPS.

For instance, the recording medium may include a hard disk, flash memory, RAM, and ROM as a built-in type device for reproducing device, or an optical disk such as CD-R or CD-RW, compact flash card, smart media, memory stick, and multimedia card as an external type device for reproducing device.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A medication management system, comprising:
a medication support device configured to recognize a medicine packet by recognizing an identification code provided to the medication packet, provide one of notification services of medicine non-compliance notification, medication notification, next medication notification, and outdoor medication notification to a user according to a medication schedule corresponding to the recognized identification code, and check a medication status of the user; and
a medication management server configured to receive the identification code recognized by the medication support device or the checked medication status of the user and transmit a medication schedule for the received identification code to the medication support device, or synchronize the found medication schedule according to the received medication status of the user.

2. The system of claim 1, further comprising a user terminal configured to receive a message including an outdoor medication notification from the medication management server and display the message to the user when the user goes out.

3. A medication support device, comprising:
a communication unit configured to communicate with a medication management server;
an identification code recognition unit configured to recognize an identification code provided to a medicine packet;
a medication management unit configured to transmit the recognized identification code to the medication management server through the communication unit, and receive a medication schedule for the recognized identification code;
a medication notification unit configured to provide a notification service by comparing the identification code of the received medication schedule with the recognized identification code;
a medicine recognition unit configured to recognize whether the user takes a medicine corresponding to the provided notification service; and
a discharge driving unit configured to store medicine packets prescribed for the user, and move the stored medicine packets forward or backward according to the provided notification service to discharge a medicine to the user.

4. The device of claim 3, wherein the medication notification unit provides the notification service as one of medicine non-compliance notification, medication notification, next medication notification, and outdoor medication notification to the user.

5. The device of claim 3, wherein the medication notification unit provides at least one of medicine taking method, medicine taking procedures, and matters that require attention according to medication instructions included in a medication schedule or an outdoor medication schedule when the notification service is the medication notification or outdoor medication notification.

6. The device of claim 3, wherein the discharge driving unit comprises:
a conveyor configured to move the stored medicine packets forward or backward by moving a provided belt so that the stored medicine packets are discharged according to the provided notification service;
a second motor configured to drive the conveyor;
a fixer configured to fix the medicine packets by moving upward and downward;
a first motor configured to drive the fixer upward and downward; and
a movement guide configured to guide movement of the medicine packets on the conveyor.

7. A medication adaptation rate management method, comprising:
recognizing a medicine packet by recognizing an identification code provided to the medicine packet loaded on a loading box at an initial period;
receiving a medication schedule for the recognized identification code by transmitting the recognized identification code to a medication management server;
providing one of medicine non-compliance notification, medication notification, next medication notification, and outdoor medication notification to the user by checking the received medication schedule according to a medicine packet discharge request from the user; and
synchronizing a medication status with the medication management server by checking the medication status of the user according to the notification provided to the user.

8. The method of claim 7, further comprising notifying the user of eliminating not-taken medicine packet among the recognized medicine packets.

9. The method of claim 7, wherein the recognizing of the medicine packet senses the identification code or moves the medicine packet backward as much as a first distance, senses the identification code or moves the medicine packet forward as much as a second distance, and moves the medicine packet forward as much as the first distance when the medicine packet is inserted or identified at the initial period.

10. The method of claim 7, wherein the providing of the notification senses the identification code or moves the medicine packet backward as much as a second distance, checks whether the medicine packet of the sensed identification code is a not-taken medicine packet, and moves the checked not-taken medicine packet forward as much as the first and second distances to discharge the not-taken medicine packet when the notification is the medication non-compliance notification according to a result of checking the received medication schedule.

11. The method of claim 7, wherein the providing of the notification senses the identification code or moves the medicine packet backward as much as a second distance, checks whether the medicine packet of the sensed identification code is a taken medicine packet, and moves the checked taken medicine packet forward as much as the first and second distances to discharge the taken medicine packet when the notification is the medication notification according to a result of checking the received medication schedule.

12. The method of claim 7, wherein the providing of the notification senses the identification code or moves the medicine packet backward as much as a second distance, checks whether the medicine packet of the sensed identification code is an outdoor medicine packet, and senses a next identification code or moves the checked outdoor medicine packet forward as much as the first and second distances to discharge the outdoor medicine packet when the notification is the outdoor medication notification.

13. The method of claim 13, wherein the providing of the notification provides at least one of medicine taking method, medicine taking procedures, and matters that require attention according to medication instructions included in an outdoor medication schedule when the notification is the outdoor medication notification.
